(19) United States
(12) Patent Application Publication
(10) Pub. No.: US 2012/0062200 A1
(43) Pub. Date: Mar. 15, 2012

(54) VOLTAGE REGULATION DEVICE AND SYSTEM EMPLOYING THE SAME

(75) Inventors: SONG-LIN TONG, Shenzhen (CN); QI-YAN LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/012,813

(22) Filed: Jan. 25, 2011

(30) Foreign Application Priority Data
Sep. 14, 2010 (CN) 201010280940.2

(51) Int. Cl. G05F 1/46

(52) U.S. Cl. 323/283

(57) ABSTRACT

A voltage regulation device employed in a voltage regulation system is for a motherboard power supply. The voltage regulation device includes a first sampling module, a voltage regulation module, a second sampling module, and a main controller. The first sampling module samples current and voltage signals from a power source through the motherboard power supply. The voltage regulation module outputs adjustable drive voltages for the motherboard power supply controlled by the main controller. The second sampling module samples current and voltage signals of the drive voltages from the motherboard power supply. The main controller receives the current and voltage signals, and converts the current and voltage signals from the first sampling module and the second sampling module to corresponding input power and output power, respectively, and the input power and the output power are calculated to generate conversion efficiencies of each drive voltage.

### BACKGROUND

1. Technical Field

The disclosure generally relates to a voltage regulation device used in a voltage regulation system.

2. Description of the Related Art

Conversion efficiency of power supply for a motherboard in an electronic device such as computer is an important indicator of power supply performance. A frequently used power supply generally includes driving units and field effect transistors (FETs) electrically connected to the driving units. The driving units are powered by an external power source, which affects and determines drive voltages of the FETs.

However, different types of FETs require different drive voltages, such that if a variety of FETs are powered by only a single external power source, it is difficult for the power supply to achieve conversion efficiency and meet system requirements.

Therefore, there is room for improvement within the art.

### BRIEF DESCRIPTION OF THE DRAWINGS

Many aspects of an exemplary voltage regulation device and system employing the same can be better understood with reference to the following drawings. The components in the drawings are not necessarily drawn to scale, the emphasis instead being placed upon clearly illustrating the principles of the exemplary voltage regulation device and system employing the same. Moreover, in the drawings, like reference numerals designate corresponding parts throughout the several views. Wherever possible, the same reference numbers are used throughout the drawings to refer to the same or like elements of an embodiment.

FIG. 1 is a block view of a voltage regulation system including a voltage regulation device electrically connected to a motherboard power supply, according to an exemplary embodiment.

FIG. 2 is circuit view of a voltage regulation device utilized in the voltage regulation system of one embodiment shown in FIG. 1.

### DETAILED DESCRIPTION

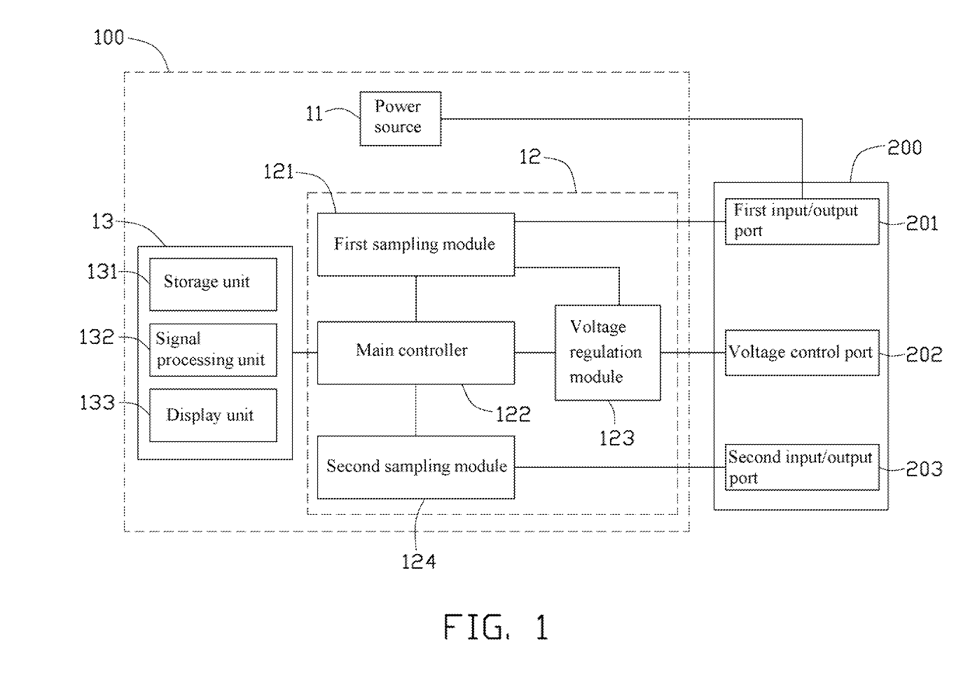

FIG. 1 is a block view of a voltage regulation system 100 electrically connected to a motherboard power supply 200, according to an exemplary embodiment. The voltage regulation system 100 is used for monitoring and regulating drive voltages of the motherboard power supply 200. The voltage regulation system 100 includes a power source 11, a voltage regulation device 12, and a computer 13. The power source 11 is electrically connected and provides operating power to the motherboard power supply 200.

The voltage regulation device 12 includes a first sampling module 121, a main controller 122, a voltage regulation module 123, and a second sampling module 124. The motherboard power supply 200 includes a first input/output (I/O) port 201, a voltage control port 202, and a second I/O port 203.

The power source 11 is electrically connected to the first I/O port 201 via which the operating power is supplied to the motherboard power supply 200. The first sampling module 121 is electrically connected to the first I/O port 201 and the main controller 122. The first sampling module 121 samples current and voltage signals from the power source 11 through the motherboard power supply 200, and transmits the sampled current and voltage signals to the main controller 122.

The main controller 122 can be a digital signal processing (DSP) integrated circuit (IC) or a digital signal processor. The main controller 122 is electrically connected to the first sampling module 121, the voltage regulation module 123, the second sampling module 124 and the computer 13. The main controller 122 is capable of receiving and processing the sampled signals from the first sampling module 121 and the second module 124. For example, the main controller 122 can measure, filter and/or compress continuous current and voltage signals from the first sampling module 121, converting the current and voltage signals to number streams.

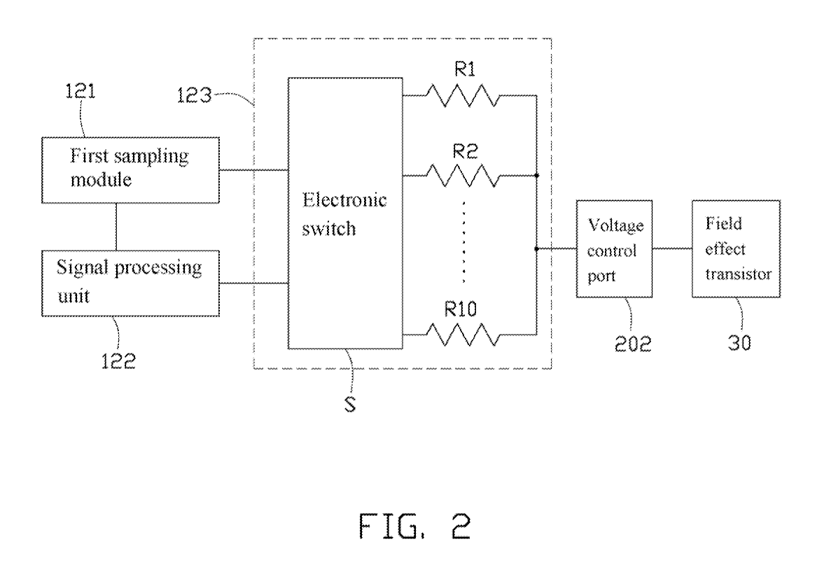

Referring to FIG. 2, the voltage regulation module 123 includes an electronic switch S and a group of resistors R1-R10. The electronic switch S is electrically connected to the first sampling module 121 and the main controller 122. The group of resistors R1-R10 is electrically connected between the electronic switch S and the voltage control port 202 of the motherboard power supply 200, and the voltage control port 202 is electrically connected to a field effect transistor (FET) 30. Thus, the sampled current and voltage signals are transmitted to the voltage control port 202 through the electronic switch S and the group of resistors R1-R10.

In this exemplary embodiment, in detail, the electronic switch S is switched on or off under the control of the main controller 122, whereby the electronic switch S is alternately electrically connected to one of the resistors R1-R10 or to all the resistors R1-R10 in sequence. Thus, the voltage control port 202 outputs adjustable drive voltages to the FET 30. In this exemplary embodiment, the drive voltages from the voltage control port 202 are in the range of 3-12V.

The second sampling module 124 is electrically connected to the main controller 122 and the second I/O port 203. The motherboard power supply 200 outputs current and voltage signals to the second sampling module 124 through the second I/O port 203, the second sampling module 124 processes, such as measures, filters and/or compresses, the continuous current and voltage signals from the second I/O 203, and transmits the processed current and voltage signals to the main controller 122.

The main controller 122 is electrically connected to the computer 13 through a universal serial bus (USB) interface, an institute of electrical and electronics engineers (IEEE) interface, or an external serial ATA (ESATA) interface. The main controller 122 receives the current and the voltage signals from the first sampling module 121 and the second sampling module 124, and converts the current and voltage signals to corresponding power signals in the form of number streams.

The computer 13 includes a storage unit 131, a signal processing unit 132, and a display unit 133. The storage unit 131 can be a memory module and is capable of storing software or different application programs to automatically perform different operations. In this exemplary embodiment, the storage unit 131 includes a formula for calculating the power conversion efficiency of ηₙ=ηₙ=(POₙ+Pᵥᵣ)/PIₙ, (n=0, 1, 2, 3 . . . X), where Pᵥᵣ is a power constant and can be calculated when the motherboard power supply 200 is not connected to any resistor, POₙ is an output power of the drive voltage from the motherboard power supply 200, and PIₙ is an input power of the drive voltage from the motherboard power supply 200.

The signal processing unit 132 is capable of calculating the power conversion efficiency according to the input power and output power by the formula. For example, when the drive voltage is 3V, the output power is PO₁, and the input power is PI₁, η₁=(PO₁+Pᵥᵣ)/PI₁. Similarly, η₂=(PO₂+Pᵥᵣ)/PI₂, η₃=(PO₃+Pᵥᵣ)/PI₃, and ηₓ=(POₓ+Pᵥᵣ)/PIₓ. The signal processing unit 132 is further capable of generating curve or schematic illustrations of a relationship between drive voltages and corresponding conversion efficiencies, and transmitting the curves or the schematics to the display unit 133 for viewing, allowing analysis thereof and determination of an optimal range of drive voltages for the motherboard power supply 200.

The drive voltage of 3V is used here as an example to illustrate the operation of the voltage regulation system 100. In testing, the voltage regulation system 100 is electrically connected to the motherboard power supply 200. Specifically, the first I/O port 201 is electrically connected to the power source 11 and the first sampling module 121, the voltage control port 202 is electrically connected to the voltage regulation module 123, and the second I/O port 203 is electrically connected to the second sampling module 124. The electronic switch S is switched on under the control of the main controller 122 to electrically connect the R1, and the voltage regulation module 123 outputs a drive voltage of 3V to the voltage control port 202.

The first sampling module 121 samples current and voltage signals from the power source 11 through the first I/O port 201, and the second sampling module 124 samples current and voltage signals from the second I/O port 203. The sampled current and voltage signals from the first sampling module 121 and the second sampling module 124 are transmitted to the main controller 122. The main controller 122 converts the current and voltage signals from the first sampling module 121 to corresponding input power, and converts the current and voltage signals from the second sampling module 124 to corresponding output power. The signal processing unit 132 then calculates the power conversion efficiency according to the input power and the output power, where the power conversion efficiency of 3V is η₁=(PO₁+Pᵥᵣ)/PI₁, and n=1.

The electronic switch S is switched on to electrically connect the resistors R2-R10 in sequence, and the voltage regulation module 123 outputs the drive voltage of 3V to the voltage control port 202. Thus, different power conversion efficiencies are calculated by the formula: ηₙ=(POₙ+Pᵥᵣ)/PIₙ. Similarly, when the drive voltage is 3-12V, the electronic switch S is switched on to electrically connected to one of resistors R1-R10, therefore, different power conversion efficiencies are calculated according to the input power and output power by the formula of ηₙ=(POₙ+Pᵥᵣ)/PIₙ. The signal processing unit 132 generates curves or schematics according to the power conversion efficiencies. The display unit 133 displays the curve or schematic illustrations of the relationship between drive voltages and corresponding conversion efficiencies, allowing selection and acquisition of optimal drive voltages.

In summary, in the exemplary embodiment of the voltage regulation system 100, the voltage regulation module 123 can provide and output different drive voltages to the voltage control port 202, the voltage regulation device 12 regulates and processes the input and output voltage from the motherboard power supply 200, and the computer 13 generates and produces power conversion efficiencies corresponding to the drive voltages. Thus, analysis and selection of optimal drive voltages are enabled, which enhance conversion efficiency of the motherboard power supply 200.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A voltage regulation device used for a motherboard power supply, the voltage regulation device comprising:
a first sampling module electrically connected to a first input/output port of the motherboard power supply, the first sampling module for sampling current and voltage signal from a power source through the first input/output port;
a voltage regulation module electrically connected to a voltage control port of the motherboard power supply and the first sampling module, the voltage regulation module for providing adjustable drive voltages for the voltage control port;
a second sampling module electrically connected to a second input/output port of the motherboard power supply, the second sampling module for sampling current and voltage signal of the drive voltages from the second input/output port; and
a main controller electrically connected to the first sampling module, the voltage regulation module and the second sampling module, wherein the main controller receives the sampled current and voltage signals from the first sampling module, and converts the current and voltage signals to corresponding input power, the voltage regulation module outputs the adjustable drive voltage to the voltage control port controlled by the main controller, the main controller receives and converts the sampled current and voltage signals from the second sampling module to corresponding output power, the input power and the output power are calculated to generate conversion efficiencies of each drive voltage.

2. The voltage regulation device as claimed in claim 1, wherein the main controller is a digital signal processing integrated circuit or a digital signal processor.

3. The voltage regulation device as claimed in claim 1, wherein the voltage regulation module comprises an electronic switch and a group of resistors, the electronic switch is electrically connected to the first sampling module to receive the sampled voltage signal, the group of resistors is electrically connected between the electronic switch and the voltage control port to provide adjustable drive voltages for the voltage control port.

4. The voltage regulation device as claimed in claim 3, wherein the electronic switch is switched on under the control of the main controller to electrically connect to the resistors, the voltage regulation module provides and outputs different adjustable drive voltages.

5. The voltage regulation device as claimed in claim 4, wherein the electronic switch is switched on or off under the control of the main controller, the electronic switch is alternately and electrically connected to one of the resistors or is electrically connected to the resistors sequence, and the voltage control port outputs adjustable drive voltages.

6. The voltage regulation device as claimed in claim 1, wherein the main controller is electrically connected to a computer through a universal serial bus interface, an institute of electrical and electronics engineers interface, or an external serial ATA interface.

7. A voltage regulation device used for a motherboard power supply comprising a first input/output port, a voltage control port and a second input/output port, the voltage regulation device comprising:
a first sampling module electrically connected to the first input/output port, the first sampling module for sampling current and voltage signals from a power source through the first input/output port;
a voltage regulation module electrically connected to the first sampling and the voltage control port, the voltage regulation module for providing and outputting adjustable drive voltages for the voltage control port;
a second sampling module electrically connected to the second input/output port, the second sampling module for sampling current and voltage signals of the drive voltages from the second input/output port; and
a main controller electrically connected to the first sampling module, the voltage regulation module and the second sampling module, wherein the main controller receives the sampled current and voltage signals, converts the sampled current and voltage signals from the first sampling module and the second sampling module to corresponding input power and output power, respectively, and the input power and the output power are transmitted to a computer and are calculated to generate conversion efficiencies of the drive voltages.

8. The voltage regulation device as claimed in claim 7, wherein the main controller is a digital signal processing integrated circuit or a digital signal processor.

9. The voltage regulation device as claimed in claim 7, wherein the voltage regulation module comprises an electronic switch and a group of resistors, the electronic switch is electrically connected to the first sampling module to receive the sampled voltage signal, the group of resistors is electrically connected between the electronic switch and the voltage control port to provide adjustable drive voltage for the voltage control port.

10. The voltage regulation device as claimed in claim 9, wherein the electronic switch is switched on under the control of the main controller to electrically connect to the resistors, the voltage regulation module provides and outputs different adjustable drive voltages.

11. The voltage regulation device as claimed in claim 10, wherein the electronic switch is switched on or off under the control of the main controller, the electronic switch is alternately and electrically connected to one of the resistors or is electrically connected to the resistors sequence, and the voltage control port outputs adjustable drive voltages.

12. The voltage regulation device as claimed in claim 7, wherein the main controller is electrically connected to the computer through a universal serial bus interface, an institute of electrical and electronics engineers interface, or an external serial ATA interface.

13. A voltage regulation system used for a motherboard power supply comprising a first input/output port, a voltage control port and a second input/output port, the voltage regulation system comprising:
a voltage regulation device comprising:
a first sampling module electrically connected to the first input/output port, the first sampling module for sampling current and voltage signals from a power source through the first input/output port;
a voltage regulation module electrically connected to the first sampling and the voltage control port, the voltage regulation module for providing and outputting adjustable drive voltages for the voltage control port;
a second sampling module electrically connected to the second input/output port, the second sampling module for sampling current and voltage signals of the drive voltages from the second input/output port; and
a main controller electrically connected to the first sampling module, the voltage regulation module and the second sampling module to receive the sampled current and voltage signals from the first sampling module and the second sampling module; and
a computer electrically connected to main controller, wherein the main controller converts the current and voltage signals from the first sampling module to corresponding input power, the main controller converts the sampled current and voltage signals from the second sampling module to corresponding output power, the computer receives and processes the input power and the output power, and calculates the input and output powers to generate conversion efficiencies of the drive voltages.

14. The voltage regulation system as claimed in claim 13, wherein the voltage regulation module comprises an electronic switch and a group of resistors, the electronic switch is electrically connected to the first sampling module to receive the sampled voltage signal, the group of resistors is electrically connected between the electronic switch and the voltage control port to provide adjustable drive voltage for the voltage control port.

15. The voltage regulation system as claimed in claim 14, wherein the computer comprises a storage unit, the storage unit comprises a formula for calculating the power conversion efficiency: ηₙ=ηₙ=(POₙ+Pᵥᵣ)/PIₙ, where n=0, 1, 2, 3 . . . X, Pᵥᵣ is a power constant and can be calculated when the motherboard power supply is disconnected to any resistor, POₙ is an output power of the drive voltage from the motherboard power supply, and PIₙ is an input power of the drive voltage from the motherboard power supply.

16. The voltage regulation system as claimed in claim 14, wherein the electronic switch is switched on under the control of the main controller to electrically connect to the resistors, the voltage regulation module provides and outputs different adjustable drive voltages.

17. The voltage regulation system as claimed in claim 13, wherein the electronic switch is switched on or off under the control of the main controller, the electronic switch is alternately and electrically connected to one of the resistors or is electrically connected to the resistors sequence, and the voltage control port outputs adjustable drive voltages.

18. The voltage regulation system as claimed in claim 15, wherein the computer further comprises a signal processing unit and a display unit, the signal processing unit calculates the conversion efficiency according to the input power and the output power by the formula, and generates a curve or a schematic illustrations of a relationship between drive voltages and corresponding conversion efficiencies, and the display unit displays the curve or schematic illustrations.

19. The voltage regulation system as claimed in claim 13, wherein the main controller is a digital signal processing integrated circuit or a digital signal processor.

20. The voltage regulation system as claimed in claim 13, wherein the main controller is electrically connected to the computer through a universal serial bus interface, an institute of electrical and electronics engineers interface, or an external serial ATA interface.
